(19) United States
(12) Patent Application Publication
(10) Pub. No.: US 2024/0146833 A1
(43) Pub. Date: May 2, 2024

(54) Phone Case Tripod

(71) Applicant: Alyssa Benavidez, Laguna, NM (US)

(72) Inventor: Alyssa Benavidez, Laguna, NM (US)

(21) Appl. No.: 17/979,145

(22) Filed: Nov. 2, 2022

(51) Int. Cl. H04M 1/04; F16M 11/20; F16M 11/22; H04B 1/3888

(52) U.S. Cl. CPC H04M 1/04; F16M 11/2078; F16M 11/22; H04B 1/3888

(57) ABSTRACT

Alyssa's Phone Case is the only product of its kind that is strategically developed with a built-in tripod that requires no extra equipment to establish positioning. This unprecedented product is uniquely designed to double as a selfie stick and possesses a three hundred and sixty degree ball joint that makes switching from vertical to horizontal an incredibly simple maneuver. Furthermore, Alyssa's Phone Case comes in a variety of different sizes and colors to accommodate specific phone types and overall user preference.

### BACKGROUND

All content creators know the struggle of capturing the perfect image and/or video while directing the individual behind the camera on how best to position the media device, i.e., phone. Furthermore, finding or even asking a random person to assist in taking pictures, can be incredibly stressful. There have been no products available as original equipment or as an aftermarket to address this problem.

An apparatus for content creators that assist and simplify the process of taking selfie's and videos unassisted is not being met by any known device or system at present. There have been no products available as original equipment or as an aftermarket to address this problem either.

### SUMMARY OF THE INVENTION

The main purpose of the phone case tripod is to provide content creators a way of capturing the perfect image and/or video while directing the individual behind the camera on how best to position the media device, i.e., phone. Without needing to have another person assist in taking pictures.

The disclosed cell phone case accessory for a cell phone includes a socket configured to mount to a back side of the cell phone and a ball joint received into the socket and configured with 3 subsockets. A tripod joined to the ball joint includes a center leg and two lateral legs each joined via one of the three subsockets respectively to the ball joint, wherein each of the center leg and lateral legs comprise a ball at one end received into a respective subsocket and a free end thereof.

### BRIEF DESCRIPTION OF THE DRAWINGS

FIG. 1 is a back collapsed view of the phone case tripod in accordance with an embodiment of the present disclosure.

FIG. 2 is a side right angle extended sitting position of the phone case tripod in accordance with an embodiment of the present disclosure.

FIG. 3 is a back extended selfie stick configuration of the phone case tripod in accordance with an embodiment of the present disclosure.

FIG. 4 is a back fully extended standing position of the phone case tripod in accordance with an embodiment of the present disclosure.

FIG. 5 is a side fully extended standing position of the phone case tripod on an end thereof in accordance with an embodiment of the disclosure.

FIG. 6 is a cut away side view of the ball joint and the subsockets and tripod leg balls in relation thereto in accordance with an embodiment of the present disclosure.

FIG. 7 is an end view of the tripod in a fully extended 360 configuration in accordance with an embodiment of the present disclosure.

FIG. 8 is a view of the subsockets in the ball joint for receiving tripod leg balls in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

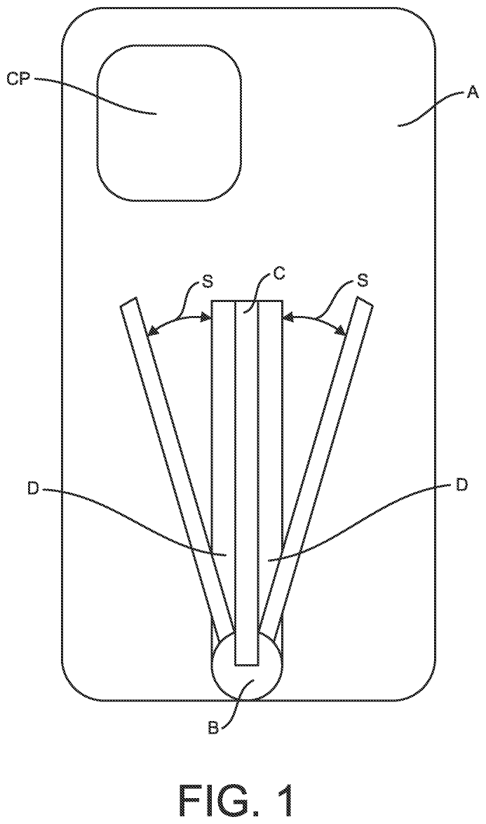

FIG. 1 is a back collapsed view of the phone case tripod showing: phone case referenced as A, a tripod that supports the phone in different angles or works as a selfie stick referenced as center leg C and lateral legs D, and a 360 ball joint referenced as B, in accordance with an embodiment of the present disclosure. The angles referenced as S show a lateral spread of the lateral legs D from the center leg C. The phone case A has a rigid backing in order to support the ball joint B and hold the phone in a rigid position with respect to the tripod legs C and D. A camera of the cell phone CP is also depicted.

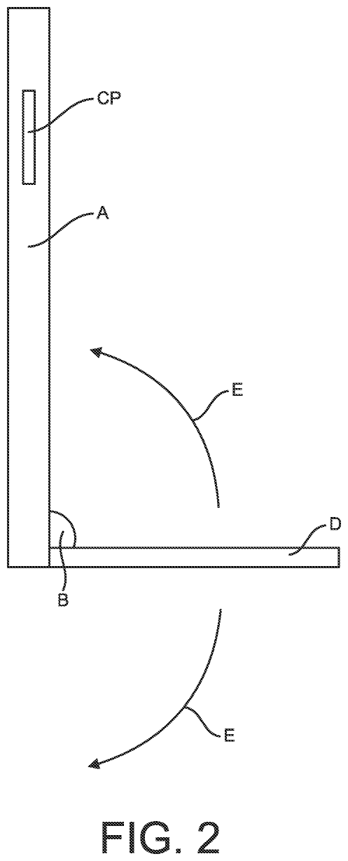

FIG. 2 is a side right angle sitting position of the phone case tripod showing: phone case referenced as A, a tripod that supports the phone in different angles or works as a selfie stick referenced as B, 360 ball joint referenced as C, in accordance with an embodiment of the present disclosure. The angle E is depicted between the tripod and a back of the cell phone or cell phone case.

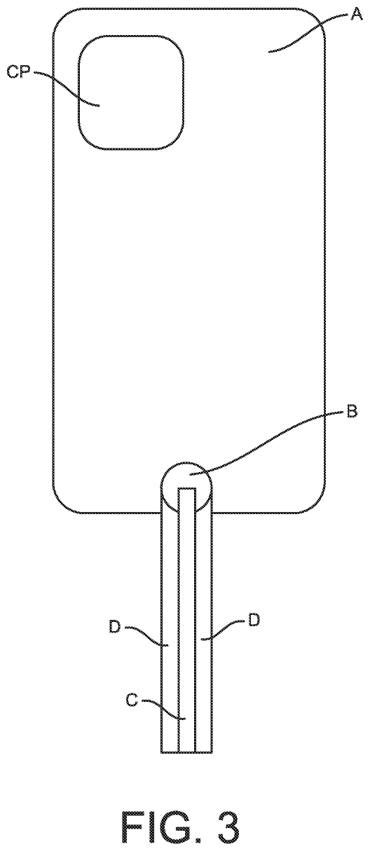

FIG. 3 is a back extended selfie stick configuration of the phone case tripod showing: phone case referenced as A, a tripod that supports the phone in different angles or works as a selfie stick referenced as B, 360 ball joint referenced as C, in accordance with an embodiment of the present disclosure. The tripod legs C and D are adjacent each other so there is no spread angle S but extended at 180 degrees from the cell phone or cell phone case.

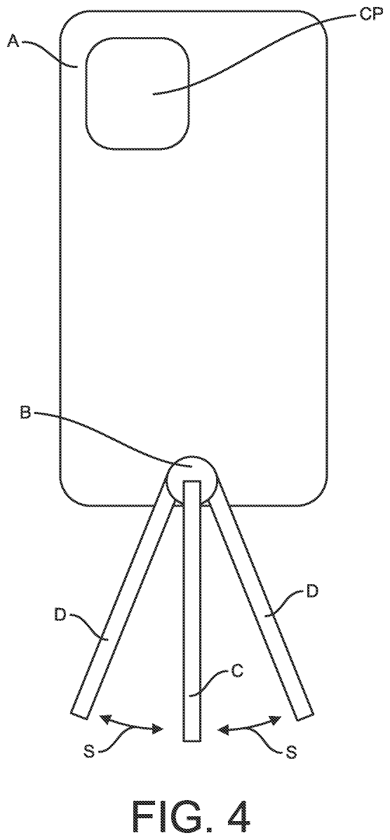

FIG. 4 is a back fully extended standing position of the phone case tripod showing: phone case referenced as A, a tripod that supports the phone in different angles or works as a selfie stick referenced as B, 360 ball joint referenced as C, in accordance with an embodiment of the present disclosure. The spread angle S is depicted at a nomimal 30 degrees but can extend up to 45 degrees according to needs of the photographer and videographer.

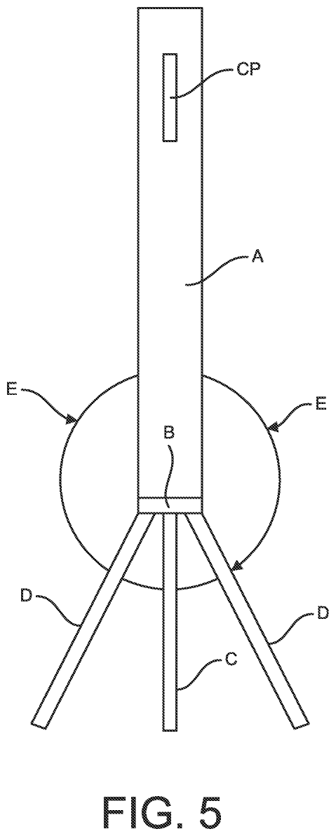

FIG. 5 is a side fully extended standing position of the phone case tripod in accordance with an embodiment of the disclosure. The socket for the ball joint is disposed at an end of the cell phone or cell phone case to allow for greater freedom in movement of the tripod legs. Same reference letters as depicted in other drawings herein refer to similar and same limitations.

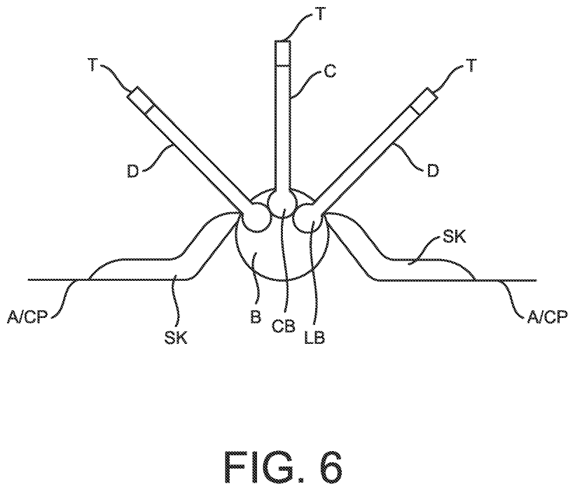

FIG. 6 is a cut away side view of the ball joint and the subsockets and tripod leg balls in relation thereto in accordance with an embodiment of the present disclosure. The center leg ball CB and the lateral leg balls LB are shown embedded or received into the ball joint B which itself is received or embedded into the socket Sk. The free ends of the tripod legs C and D are tipped with a frictional material T which is anti-slipping to a placement on a surface thereto. Same reference letters as depicted in other drawings herein refer to similar and same limitations.

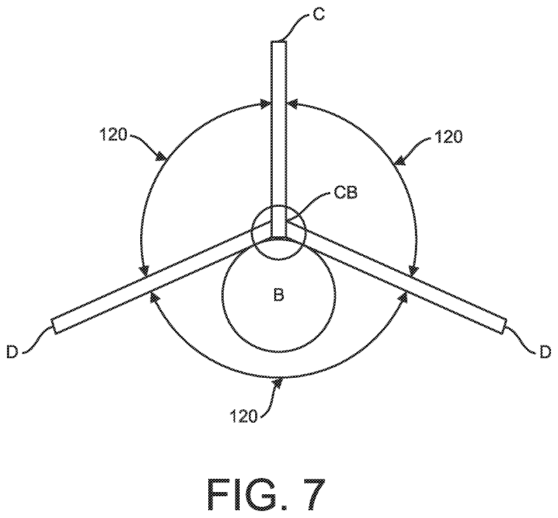

FIG. 7 is an end view of the tripod in a fully extended 360 degree configuration in accordance with an embodiment of the present disclosure. The ball joint B is shown underneath the respective tripod leg balls received therein such as CB. The tripod legs can swing S into the 120 degree position or into a 360 degree position for use as a selfie stick.

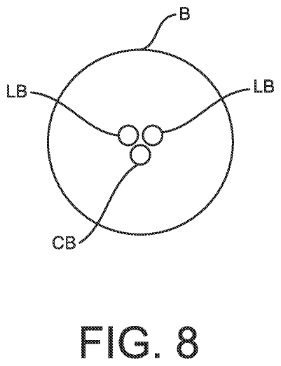

FIG. 8 is a view of the subsockets in the ball joint for receiving tripod leg balls in accordance with an embodiment of the present disclosure.

The present disclosed phone case tripod, also known as “Alyssa's Phone Case”, offers a modern accessory that allows users to turn their phone into their personal cameraman and therefore ensures they are able to film themselves with ease and without the necessity of extra assistance/manpower. Expanding on the initial design of an average phone case, Alyssa's Phone Case introduces a novel tripod support covering that will rotate in and out of the case, functioning as a means to hold itself up, independently. Unlike an average phone stand that holds the phone up at only a forty five degree angle, Alyssa's Phone Case provides users with the freedom to get creative at any angle with help from the three hundred and sixty degree ball joint rotation feature. Horizontally or vertically, Alyssa's Phone Case aligns the angels just right for capturing the perfect shot and/or video. This innovative, top-quality product ensures a fully operational phone protection case that doubles as the perfect accessory, enabling users to self-capture the best potential image. As a result, Alyssa's Phone Case will benefit all content creators or individuals who seek to have an effective way of taking their own pictures, without the need to ask for help.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A cell phone case accessory for a cell phone and comprising:
a socket configured to mount to a back side of the cell phone;
a ball joint received into the socket and configured with 3 subsockets;
a tripod joined to the ball joint and comprising a center leg and two lateral legs each joined via one of the three subsockets respectively to the ball joint,
wherein each of the center leg and lateral legs comprise a ball at one end received into a respective subsocket and a free end thereof.

2. The cell phone accessory of claim 1, further comprising a cell phone case integrated with the socket and receiving the ball joint.

3. The cell phone accessory of claim 1, wherein the mount is an adhesive mount.

4. The cell phone accessory of claim 1, wherein the mount is a magnetic mount.

5. The cell phone accessory of claim 1, wherein the center leg and the lateral legs are collapsible together for use as a selfie stick.

6. The cell phone accessory of claim 1, wherein the three subsockets in the ball joint are clustered together to enable any one of the tripod legs to rotate 270 degrees at one time or separately.

7. The cell phone accessory of claim 1, wherein the ball joint rotates up to degrees in the socket.

8. The cell phone accessory of claim 1, wherein each of the three free ends is tipped with a frictional tip for gripping a surface.

9. The cell phone accessory of claim 1, further comprising a collapsed configuration comprising the tripod legs together and parallel the back of the cell phone.

10. The cell phone accessory of claim 1, further comprising a sitting configuration comprising the tripod extended ninety degrees from the back of the cell phone and each tripod leg swung out flat on a surface with up to a 45 degrees swing between each other.

11. The cell phone accessory of claim 1, further comprising a standing configuration comprising the tripod extended 180 degrees from the back of the cell phone and each tripod leg swung out flat on a surface with up to a 120 degrees swing between each other.

12. The cell phone accessory of claim 1, further comprising the socket configured to mount onto an end of the cell phone.

13. The cell phone accessory of claim 1, further comprising a cell phone case integrated with the socket on an end of the cell phone case on an end of the cell phone.

14. The cell phone accessory of claim 1, wherein the ball joint is detachable from the socket via a tightening and loosening screw in the socket.

15. The cell phone accessory of claim 1, wherein a receiving of a ball into a subsocket is made more frictional via a particulate powder supplement such as a fine graphite powder into a joint thereof.
